(19) United States
(12) Patent Application Publication
(10) Pub. No.: US 2004/0021672 A1
(43) Pub. Date: Feb. 5, 2004

(54) Image display system, projector, image processing method, and information recording medium

(76) Inventor: Osamu Wada, Nagano-ken (JP)

Correspondence Address: Oliff & Berridge, PO Box 19928, Alexandria, VA, 22320, US

(21) Appl. No.: 10/362,543

(22) PCT Filed: Jun. 26, 2002
(86) PCT No.: PCT/JP02/06394

(30) Foreign Application Priority Data
Jun. 26, 2001 (JP) 2001192953

(51) Int. Cl. G09G 5/02

(52) U.S. Cl. 345/591

(57) ABSTRACT

To provide an environment-compliant image display system, a projector, an image processing method and an information storage medium, which can more accurately reproduce a color appearance of an image adaptable to a target color, a target profile correcting section (166) for correcting target profiles in a target profile storing section (162) based on environmental information from a color light sensor (60); a color gamut computing section (160) for computing a displayable color gamut based on the target profile, the environmental information and the projector profiles in the projector profile storing section (164); a matrix generating section (122) for generating a transforming matrix according to the relationship between a target color gamut and the displayable color gamut, and a matrix transforming section (124) for transforming the image information using the generated transforming matrix are provided to transform image information and to display the image.

### TECHNICAL FIELD

The present invention relates to an environment-compliant image display system, a projector, an image processing method and an information storage medium.

### BACKGROUND ART

To reproduce color appearances equivalent to target colors based on image types such as sRGB and image display methods such as NTSC, color transform systems such as CMS (Color Management System) have been proposed.

Since there are influences due to ambient lights such as illuminating light and sunlight when an image color adaptable to the target color is to be reproduced, image display systems must transform image information in consideration of the viewing environment.

However, since the human's eyes gradually accommodate to an ambient environment, it is difficult for the image display system to reproduce the color appearance of an image equivalent to the target color only by transforming the image information in consideration of the viewing environment.

Furthermore, when the image display system transforms the image information in accordance with the target color and/or viewing environment, it must generate transformational information to be used in the transformation. However, the memory area of the image display system will be stressed by previously storing the transformational information therein for all possible target colors and viewing environments.

In addition, the image display system has to transform the image information generated at real time.

### DISCLOSURE OF THE INVENTION

In view of the aforementioned problems, it is an object of the present invention to provide an environment-compliant image display system, a projector, an image processing method and an information storage medium, all of which can more accurately reproduce the color appearance of an image adaptable to the target color.

(1) To this end, according to the present invention, there is provided an image display system that displays an image by transforming image information used to display the image so as to reproduce a target color, based on environmental information from a viewing environment grasp means for grasping a viewing environment in a display region of the image; the image display system comprising:

target color information correcting means for correcting target color information indicating the target color, based on the environmental information and adaptive color shift information indicating an adaptive color shift;

matrix generating means for generating a transforming matrix so as to display the image adaptable to the viewing environment and the target color, based on the corrected target color information;

matrix transforming means for transforming the image information, based on the generated transforming matrix; and

image display means for displaying the image, based on the transformed image information.

(2) According to the present invention, there is provided an image display system that displays an image by transforming image information used to display the image so as to reproduce a target color, based on environmental information from a viewing environment grasp section grasping a viewing environment in a display region of the image; the image display system comprising:

target color information correcting section correcting target color information indicating the target color, based on the environmental information and adaptive color shift information indicating an adaptive color shift;

matrix generating section generating a transforming matrix so as to display the image adaptable to the viewing environment and the target color, based on the corrected target color information;

matrix transforming section transforming the image information, based on the generated transforming matrix; and

image display section displaying the image, based on the transformed image information.

(3) According to the present invention, there is provided a projector that projects an image by transforming image information used to display the image so as to reproduce a target color, based on environmental information from a viewing environment grasp means for grasping a viewing environment in a display region of the image, the projector comprising:

target color information correcting means for correcting target color information indicating the target color, based on the environmental information and adaptive color shift information indicating an adaptive color shift;

matrix generating means for generating a transforming matrix so as to display the image adaptable to the viewing environment and the target color, based on the corrected target color information;

matrix transforming means for transforming the image information, based on the generated transforming matrix; and

image display means for displaying the image, based on the transformed image information.

(4) According to the present invention, there is provided a projector that projects an image by transforming image information used to display the image so as to reproduce a target color, based on environmental information from a viewing environment grasp section grasping a viewing environment in a display region of the image, the projector comprising:

target color information correcting section correcting target color information indicating the target color, based on the environmental information and adaptive color shift information indicating an adaptive color shift;

matrix generating section generating a transforming matrix so as to display the image adaptable to the viewing environment and the target color, based on the corrected target color information;

matrix transforming section transforming the image information, based on the generated transforming matrix; and

image display section displaying the image, based on the transformed image information.

(5) According to the present invention, there is provided an image processing method of transforming image information used to display an image so as to reproduce a target color, based on environmental information from a viewing environment grasp means for grasping a viewing environment in a display region of the image, the method comprising the steps of:

correcting target color information indicating the target color, based on the environmental information and adaptive color shift information indicating an adaptive color shift;

generating a transforming matrix so as to display the image adaptable to the viewing environment and the target color, based on the corrected target color information, and

transforming the image information, based on the generated transforming matrix.

(6) According to the present invention, there is provided a computer-readable information storage medium storing a program for transforming image information used to display an image so as to reproduce a target color, based on environmental information from a viewing environment grasp means for grasping a viewing environment in a display region of the image, the program causing a computer to function as:

target color information correcting means for correcting target color information indicating the target color, based on the environmental information and adaptive color shift information indicating an adaptive color shift;

matrix generating means for generating a transforming matrix so as to display the image adaptable to the viewing environment and the target color, based on the corrected target color information; and

matrix transforming means for transforming the image information, based on the generated transforming matrix.

In accordance with the present invention, the target color information adaptable to the viewing environment and adaptive color shift can be applied to the color transformation by correcting the target color information, based on the environmental information and adaptive color shift information by the image display system and the like. Thus, the image display system and the like can reproduce the color appearance of the image adaptable to the target color.

Note that the term “adaptive color shift” used herein means a change of adaptation in human eyes when they are shifted from their original condition to a condition in the viewing environment.

According to the present invention, furthermore, the image display system and the like can perform the transformation at higher speeds and reduce the storage area occupied by the transforming information by generating the transforming matrix as transforming information and transforming the image information using the generated transforming matrix, in comparison with a case where a look-up table (hereinafter called “LUT”) is used as transforming information.

Note that the term “target color” used herein means an ideal color based on, for example, an image display method (e.g., NTSC, PAL, SECAM, or the like) or an image type (e.g., RGB, sRGB, or the like) that are selected by a user.

(7) In the image display system and the projector, the adaptive color shift information may be determined based on the ratio between a color gamut area capable of being displayed by the image display means under a darkroom condition and a color gamut area capable of being displayed by the image display means in the viewing environment.

(8) In the image processing method and the information storage medium, the adaptive color shift information may be determined based on the ratio between a color gamut area capable of being displayed by the image display means under a darkroom condition and a color gamut area capable of being displayed by the image display means in the viewing environment.

Thus, the image display system and the like can perform the compensation of the target color information in consideration of the adaptive color shift for a reduced time period. This is because the adaptive color shift is more influenced by the illuminating light and the like and because the color gamut areas are also reflected by the influence of the illuminating light. Thus, the image display system and the like can compute the color gamut area for a reduced time period, thereby the adaptive color shift can be reflected to the computed results by the computation in a pseudo manner.

(9) The image display system and the projector may further comprise:

a color gamut computing means for computing a displayable color gamut which is a color gamut capable of being displayed by the image display means in the viewing environment, based on the environmental information and the corrected target color information,

wherein the matrix generating means may generate the transforming matrix which differs among the cases where the displayable color gamut is wider than a target color gamut indicating the color gamut of the target color, where the displayable color gamut is narrower than the target color gamut, where the displayable color gamut is equal to the target color gamut, and where the displayable color gamut includes both overlapping and non-overlapping portions with the target color area.

(10) The information storage medium may store a program for causing a computer to function as color gamut computing means for computing a target color gamut which is a color gamut based on the image characteristics and for computing a displayable color gamut which is a color gamut capable of being displayed by the image display means in the viewing environment, based on the environmental information,

wherein the matrix generating means may generate the transforming matrix which differs among the cases where the displayable color gamut is wider than the target color gamut, where the displayable color gamut is narrower than the target color gamut, where the displayable color gamut is equal to the target color gamut, and where the displayable color gamut includes both overlapping and non-overlapping portions with the target color area.

(11) When the transforming matrix is generated, a target color gamut which is a color gamut based on the image characteristics is computed, and at the same time, the displayable color gamut which is a color gamut displayable by the image displaying means in the viewing environment is computed based on the environmental information, and

wherein the transforming matrix, which differs among the cases where the displayable color gamut is wider than the target color gamut, where the displayable color gamut is narrower than the target color gamut, where the displayable color gamut is equal to the target color gamut, and where the displayable color gamut includes both overlapping and non-overlapping portions with the target color area, is generated.

Relationship between the color gamut based on the image characteristics and the color gamut which can be displayed by the image display means changes depending on the viewing environment and image characteristics. For such a reason, the color appearance of an image cannot be appropriately reproduced by a technique of transforming the image information using only an independent transforming matrix.

In accordance with the present invention, the image display system and the like can more appropriately reproduce an image by generating the transforming matrix according to each of the aforementioned four cases.

(12) In the image display system, the projector and the information storage medium, furthermore, the matrix generating means may generate the transforming matrix valuing the reproducibility of hue or color gamut in the cases where the displayable color gamut is narrower than the target color gamut and where the displayable color gamut includes both overlapping and non-overlapping portions with the target color gamut.

(13) When the transforming matrix is generated, the transforming matrix valuing the reproducibility of hue or color gamut may be generated in the cases where the displayable color gamut is narrower than the target color gamut and where the displayable color gamut includes both overlapping and non-overlapping portions with the target color gamut.

Thus, the image display system and the like can more appropriately reproduce the color appearance of an image by generating the transforming matrix valuing the reproducibility of hue or color gamut.

(14) The image processing method may further comprise the steps of:

generating a calibration image prior to correcting the image information;

displaying the generated calibration image on the display region; and

grasping the viewing environment in the display region on which the calibration image is displayed and generating the environmental information.

Thus, the image display system and the like can more appropriately grasp the viewing environment by grasping the viewing environment using the calibration image. Therefore, the color appearance of an image can be reproduced more appropriately.

### BRIEF DESCRIPTION OF THE DRAWINGS

FIG. 1 is a schematic illustration of an image display system according to one embodiment of the present invention.

FIG. 2 is a diagrammatic view of an adaptive color shift.

FIG. 3 is a diagrammatic view illustrating displayable color gamut of a projector in light and dark rooms.

FIG. 4A is a diagrammatic view illustrating a case when the target color gamut is equal to the displayable color gamut while FIG. 4B is a diagrammatic view illustrating a case when the displayable color gamut wider than the target color gamut.

FIG. 5A is a diagrammatic view illustrating a case where the displayable color gamut is narrower than the target color gamut while FIG. 5B is a diagrammatic view illustrating a case when the target color gamut which includes portions overlapping and not-overlapping the displayable color gamut.

FIG. 6A is a diagrammatic view illustrating the color gamut when the color gamut is preferential while FIG. 6B is a diagrammatic view illustrating the color gamut when the hue is preferential.

FIG. 7 is a functional block diagram of a projector image processing section in a projector according to one embodiment of the present invention.

FIG. 8 is a flow chart illustrating a procedure of image processing according to one embodiment of the present invention.

FIG. 9 is a flow chart illustrating a procedure of target profile generation according to one embodiment of the present invention.

FIG. 10 is a flow chart illustrating a procedure of matrix generation and transformation according to one embodiment of the present invention.

FIG. 11 is a hardware block diagram illustrating an image processing section in a projector according to one embodiment of the present invention.

### BEST MODE FOR CARRYING OUT THE INVENTION

The present invention will now be described in connection with an image display system to which the present invention is applied and which uses a liquid crystal projector, with reference to the drawings. By the way, an embodiment shown in the following is not intended to limit the subject matter of the invention as described in the accompanying claims. In addition, all of the components described in the following embodiment are not necessarily essential as means for solving the problems of the prior art according to the invention as described in the accompanying claims.

Entire System

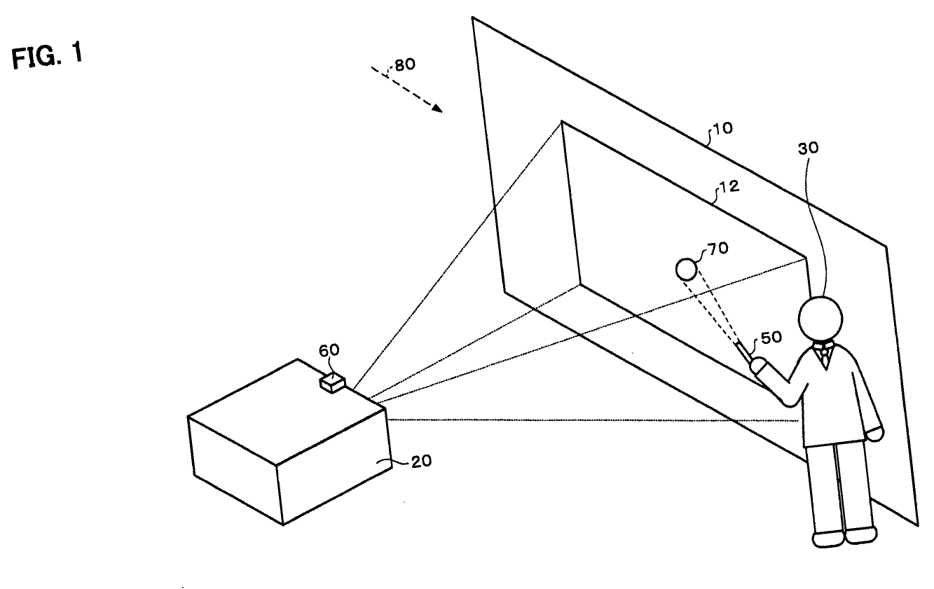

FIG. 1 is a schematic illustration of an image display system according to one embodiment of the present invention.

A projector 20, which is a kind of projection type display unit placed substantially in the front of a screen 10, projects a predetermined presentation image. A presenter 30 performs a presentation to the third person(s) while pointing a desired location on the image in an image display region 12 which is a display region on the screen 10, using a spot light 70 projected from a laser pointer 50.

When such a presentation is to be performed, the image appearance in the image display region 12 will greatly be varied depending on the type of the screen 10 and an ambient light 80. For example, the same white color projected from the projector 20 may look yellowish or tin white color, depending on the type of the screen 10. Furthermore, the same white color projected from the projector 20 may look lighter or darker, depending on the ambient light 80.

In recent years, the projector 20 is increasingly miniaturized and thus easy for carrying around. Thus, a portable projector may frequently be carried to the customer for presentation. However, it is difficult to pre-adjust the color for the environment in the customer. Therefore, the color in the projector will generally manually be adjusted in the front of the customer. This requires too much time.

In the conventional projectors, the color has been only transformed based on an input/output profile which indicates the inherent input/output characteristics thereof, but not in consideration of the viewing environment in which the image is projected. By the way, the term “profile” used herein is intended to mean a characteristic data.

It is however difficult to unify the image color appearance unless the viewing environment is considered as described. The color appearance is determined by three factors, light, light reflection or transmission and visual sense.

This embodiment realizes an image display system which can reproduce a proper color appearance in an image by grasping a target color set by a user or a specified target color and a viewing environment reflected by light and light reflection or transmission.

More particularly, the image display system is provided with a color light sensor 60 which may function as a viewing environment grasp means, as shown in FIG. 1. The environmental information from the color light sensor 60 is inputted into the projector 20. Specifically, the color light sensor 60 measures the environmental information (particularly, tristimulus values of RGB or XYZ) in the image display region 12 on the screen 10.

The projector 20 comprises a transformation means for generating a transforming matrix based on the environmental information from color light sensor 60 or the display mode selected by the user and using the generated transforming matrix to transform the image information used to display the image.

The projector 20 grasps the viewing environment based on the environmental information, so that the image display system is realized which can reproduce a proper color appearance of an image.

In addition, this embodiment more adequately reproduces the image color appearance by the projector 20 correcting the target color information based on the environmental information under the viewing environment just before a presentation is started.

Adaptive Color Shift

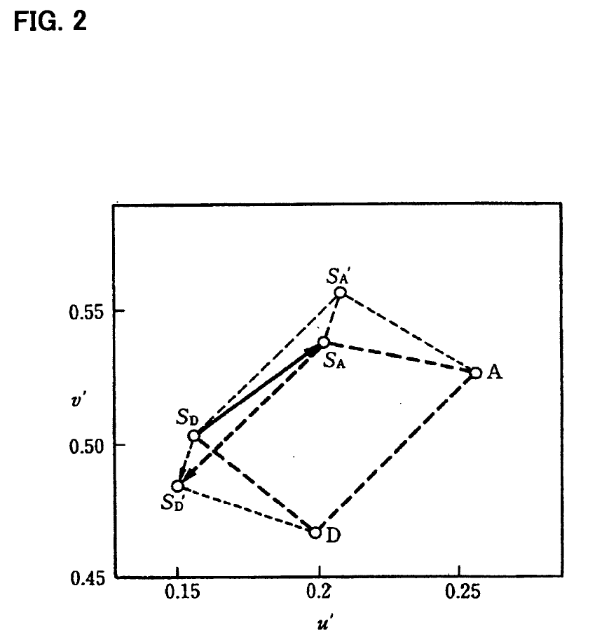

FIG. 2 is a diagrammatic view illustrating an adaptive color shift.

As described in pages 184-185 of “Color Engineering” by Noboru Ohta (published by Tokyo Denki University Press, 1993), an observer initially looks all of the objects illuminated by an incandescent electric lamp yellowish when the observer moves from the outdoor lighted up with daylight (point D of FIG. 2) into in a room illuminated by light from the incandescent electric lamp (point A of FIG. 2). As the observer's eyes get the feel of the illuminating light from the incandescent lamp, the observer will look the yellowish white color completely white.

A change of the chromaticity point at which the yellowish white color is initially observed (i.e., change from SD to SA) is referred to as calorimetric shift or illuminant shift. In addition, a change of the aforementioned sense (i.e., from SA to SD′) is referred to as adaptive color shift.

If the observer's eyes sufficiently adapt to the incandescent lamp illuminating light, the observer feels a change of color (i.e., change from SD to SD′) in which the calorimetric shift and adaptive color shift are unified. This change is referred to as resultant color shift. Therefore, a color equivalent to the color appearance of SD will be a color SA′ different from the color SA by an amount corresponding to the resultant color shift.

As described, the image display system can reproduce the equivalent color appearance under a specific viewing environment if it grasps both the calorimetric shift and adaptive color shift.

The calorimetric shift can be grasped based on the brightness value of an image under the viewing environment, but it is difficult to strictly grasp the adaptive color shift since it relates to the habituation of the human's eyes.

In this embodiment, the adaptive color shift is grasped based on the displayable color gamut area of the projector 20 under a viewing environment with illuminating light (a light room) and the displayable color gamut area of the projector 20 in a dark room.

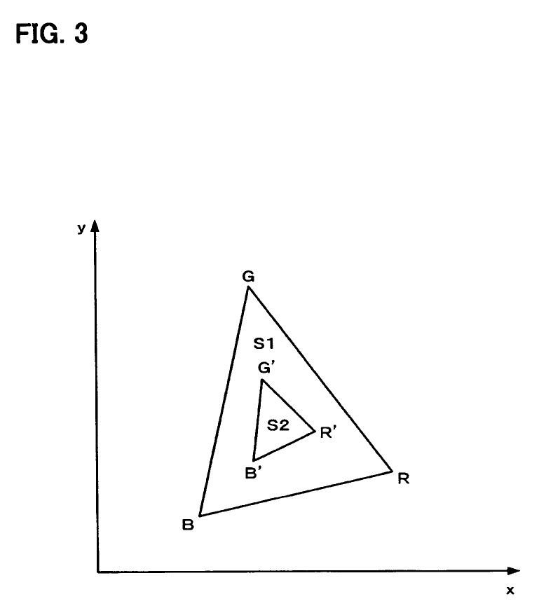

FIG. 3 is a diagrammatic view illustrating the displayable color gamut of the projector 20 in both the light and dark rooms.

As shown by an x-y chromaticity diagram in FIG. 3, the area S1 of the displayable color gamut RGB of the projector 20 in a dark room condition is larger than the area S2 of the other displayable color gamut R′G′B′ of the projector 20 in a light room. This is because the light room condition is influenced by the illuminating light or others.

In this embodiment, the image display system grasps the adaptive color shift using the aforementioned ratio of S2/S1. By the way, the inventor has found that if the above ratio of S2/S1 is used to grasp the adaptive color shift, an adequate image color appearance can be reproduced.

In this embodiment, furthermore, the image display system computes the displayable color gamut which can be displayed by the projector 20 under the viewing environment at the time of presentation practice and also determines the target color gamut in the image display mode selected by the user. The image display system further compares the target color gamut with the determined displayable color gamut and performs the image processing such that the projector 20 can display a color as close to the target color gamut as possible.

Relationship between Target Color Gamut and Displayable Color Gamut

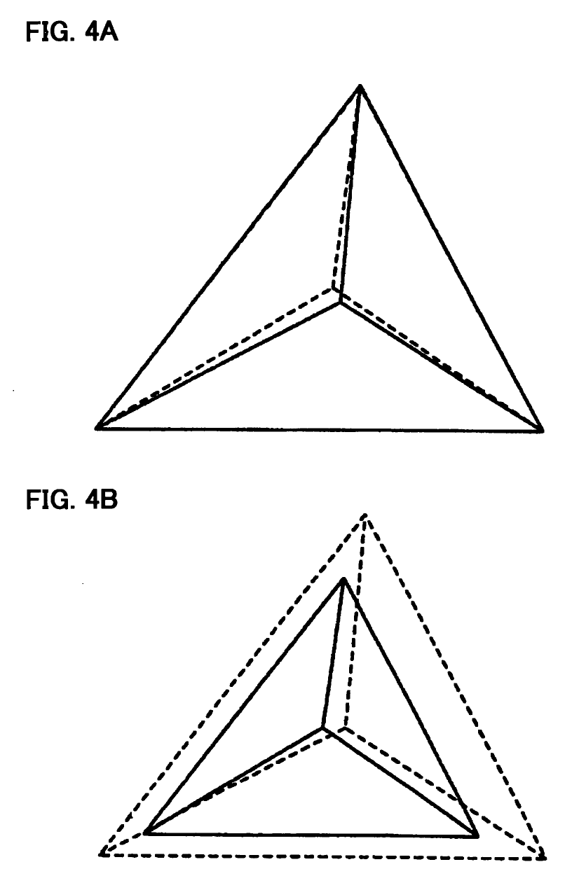

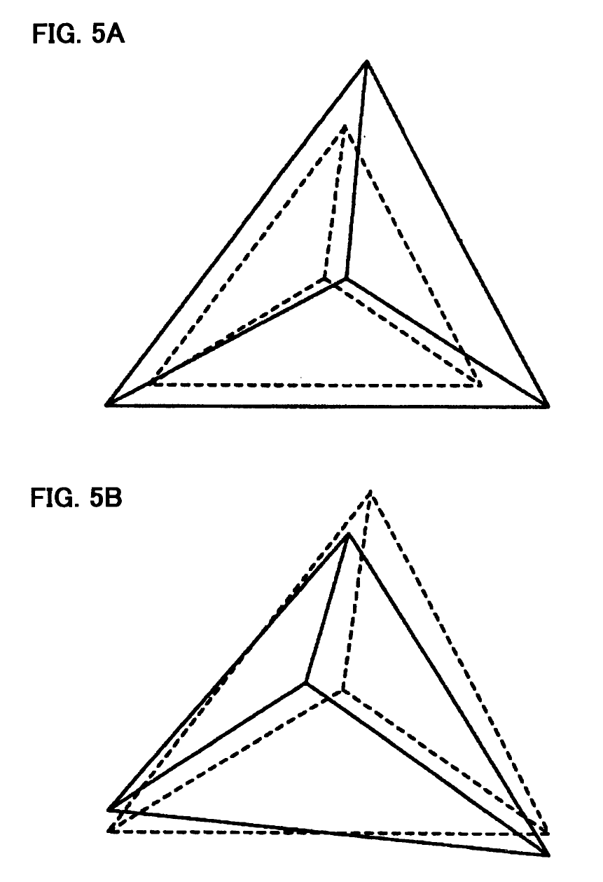

FIG. 4A is a diagrammatic view illustrating a case when the target color gamut is equal to the displayable color gamut while FIG. 4B is a diagrammatic view illustrating a case when the displayable color gamut wider than the target color gamut. FIG. 5A is a diagrammatic view illustrating a case where the displayable color gamut is narrower than the target color gamut while FIG. 5B is a diagrammatic view illustrating a case when the target color gamut which includes portions overlapping and not-overlapping the displayable color gamut.

In FIG. 4A to FIG. 5B, solid line shows target color gamut while broken line shows displayable color gamut. In addition, intersection points between lines extending from the respective vertexes in each triangle-shaped color gamut toward the center of the triangle are white-color points.

Since there are two variable factors, that is, the image characteristic and the viewing environment, the relationship between the target color gamut and the displayable color gamut is also variable and roughly classified into four patterns as shown in FIG. 4A to FIG. 5B.

The technique of transforming the image information is slightly changed depending on any one of these four different patterns. For example, if the displayable color gamut covers the entire target color gamut as shown in FIG. 4A and FIG. 4B, the image display system can adequately reproduce any target image even though the usual transforming technique is used.

However, if the displayable color gamut does not cover the entire target color gamut as shown in FIG. 5A and FIG. 5B, the image display system cannot adequately reproduce any target image according to the usual transforming technique.

In such a case, it is necessary for the image display system to perform a color gamut mapping (which is also referred to a color gamut compression) which coordinates the color of the target color gamut out of the displayable color gamut with the internal color in the target color gamut.

In this embodiment, the image display system uses either of a technique of prioritizing the color gamut or a technique of prioritizing the hue as the color gamut mapping technique.

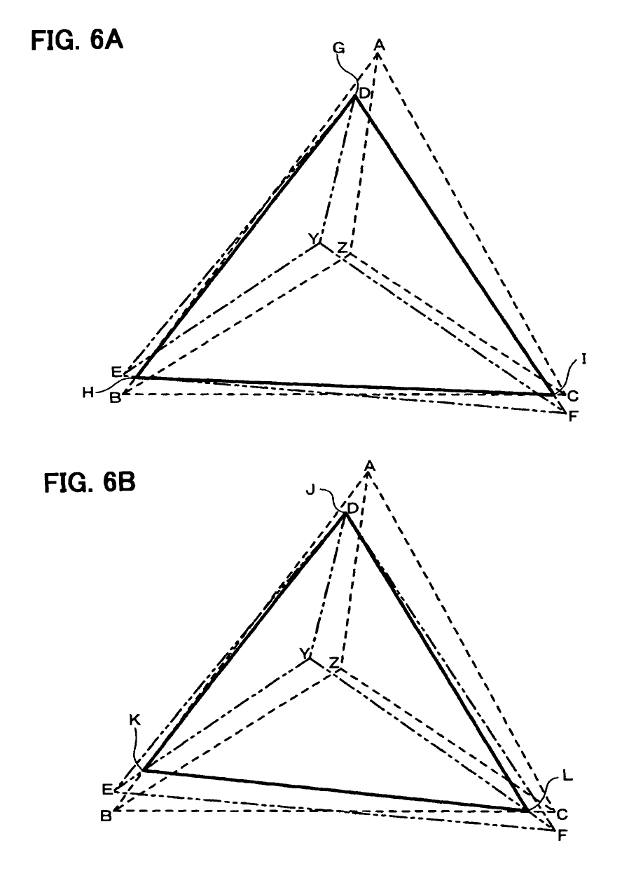

FIG. 6A is a diagrammatic view illustrating the mapping color gamut when the color gamut is preferential while FIG. 6B is a diagrammatic view illustrating the mapping color gamut when the hue is preferential.

In FIGS. 6A and 6B, broken line shows displayable color gamut while two-dotted chain line shows target color gamut. In addition, FIGS. 6A and 6B show an example of color gamut mapping when each target color gamut partially overlaps the corresponding one of the displayable color gamut, as shown in FIG. 5B.

As shown in FIG. 6A, for example, a vertex D in the target color gamut is inside the displayable color gamut ABC, but the remaining vertexes E and F are outside the displayable color gamut ABC. For such a reason, the image display system cannot directly reproduce the colors near the vertexes E and F.

Accordingly, the image display system performs the color gamut mapping to reproduce a color as close to that color as possible, if a non-reproducible color is to be displayed.

In this embodiment, the image display system performs the color gamut mapping prioritizing either of the color gamut or hue.

If the color gamut is to be prioritized, for example, the image display system may determine a point H as close to the vertex E as possible and a point I as close to the vertex F as possible from the intersecting points between the triangles DEF and ABC as possible, as shown in FIG. 6A. Since the vertex D is inside the triangular ABC, the image display system can apply the vertex D directly to a vertex G in a new color gamut.

If the color gamut is prioritized, that is, if the mapping color gamut is considered to be as large as possible, the so determined triangle GHI will be a mapping color gamut to be used.

In addition, for example, when the hue is to be prioritized, the image display system may determine intersection points K and L between segments extending from the respective vertexes in the triangle DEF to the white-color point Y and the corresponding sides of the triangle ABC, as shown in FIG. 6B. Since the vertex D is inside the triangular ABC, the image display system can apply the vertex D directly to a vertex J in a new color gamut.

When the hue is prioritized, the so determined triangle JKL will be a mapping color gamut considered such that the hue can be reproduced as exactly as possible. A color has three attributes, lightness, saturation and hue. The human's eyes are most sensitive for hue. Therefore, the image display system can cause the projector 20 to reproduce a color closer to the target color gamut by determining the mapping color gamut prioritizing the hue.

In addition, the image display system can apply the target color gamut directly to such a mapping color gamut as shown in FIGS. 4A and 4B.

In this embodiment, the image display system generates a transforming matrix used to transform the image information such that the mapping color gamut as determined above can be reproduced and uses the generated transforming matrix to transform the image information.

Functional Blocks

Functional blocks in a projector image processing section of the projector 20 for realizing the aforementioned functions will be described below.

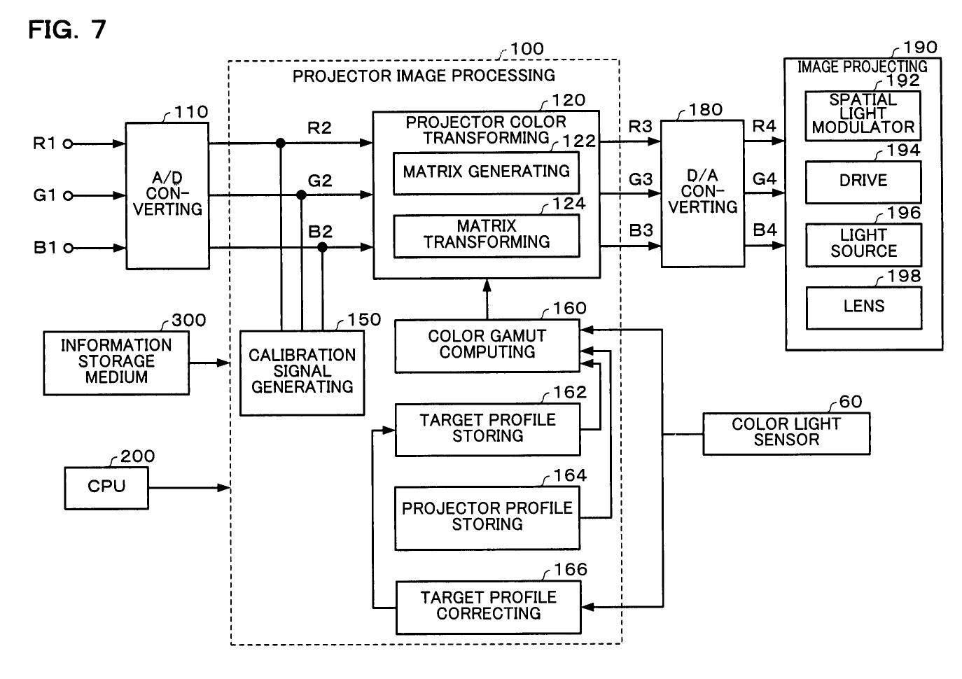

FIG. 7 is a functional block diagram of a projector image processing section 100 in the projector 20 according to one embodiment of the present invention.

The projector 20 comprises an A/D converting section 110, a projector image processing section 100, a D/A converting section 180 and an image projecting section 190.

The projector 20 inputs R1, G1 and B1 signals configuring analog type R-, G- and B-signals from PC or the like into the A/D converting section 110 and performs color transformations from digital type R2, G2 and B2 signals at the projector image processing section 100 which is controlled by CPU 200.

The projector 20 also inputs signalsR3, G3 and B3 obtained by the color transformations into the D/A converting section 180 and then inputs the analog-converted signals R4, G4 and B4 into the image projecting section 190 which is part of the image display means, thereby projecting an image.

The projector image processing section 100 comprises a projector color transforming section 120, a calibration signal generating section 150, a color gamut computing section 160, a target profile storing section 162, a projector profile storing section 164 and a target profile correcting section 166.

The calibration signal generating section 150 generates calibration image signals. The projector color transforming section 120 receives calibration image signals as digital type R2, G2 and B2 signals, as in the signals outputted from the A/D converting section 110.

Thus, the image display system can perform the calibration only by the projector 20, without input of the calibration image signals into the projector 20 from any external input device such as PC or the like, since the image display system generates calibration image signals within the projector 20.

In addition, the projector color transforming section 120 converts the respective digital R-, G- and B-signals (R2, G2 and B2 signals) from the calibration signal generating section 150 into the corresponding digital R-, G- and B signals (R3, G3 and B3 signals) suitable for use in the projector output, by referring projector profiles which are managed by the projector profile storing section 164.

The projector color transforming section 120 comprises a matrix generating section 122 for generating transforming matrixes used to transform the respective digital signals (R2, G2 and B2) which are image information and a matrix transforming section 124 which uses the generated transforming matrixes to perform the transformation of image information.

More particularly, the matrix generating section 122 generates a transforming matrix such that the mapping color gamut computed by the color gamut computing section 160 can be reproduced.

The color gamut computing section 160 computes the mapping color gamut described in connection with FIGS. 4A-6B such that a preferred color selected by the user according to the target profile (or target color information) selected by the user, the environmental information from the color light sensor 60 and such that the projector profile will be provided with an image color appearance adapting to the viewing environment.

The target profile storing section 162 has stored target profiles while the projector profile storing section 164 has stored projector profiles.

Note that the term “target profile” used herein is a kind of input/output characteristic data to be targeted. The target profiles include various types of profiles corresponding to various types of image characteristics which can be selected by the user. The term “projector profile” used herein is a kind of input/output characteristic data corresponding to the type of the projector 20 used.

The target profile correcting section 166 functions as a target color information correcting means for correcting a target color profile stored in the target profile storing section 162, based on the environmental information from the color light sensor 60.

The image projecting section 190 comprises a spatial light modulator 192, a drive 194 for driving the spatial light modulator 192 based on the signals R4, G4 and B4 from the D/A converting section 180, a light source 196 for outputting a light toward the spatial light modulator 192 and a lens 198 for projecting the light after it has been modulated at the spatial light modulator 192.

The image projecting section 190 projects an image based on the signals R4, G4 and B4.

Flow of Image Processing

Next, a flow of image processing with the use of these sections will be explained in connection with a flow chart.

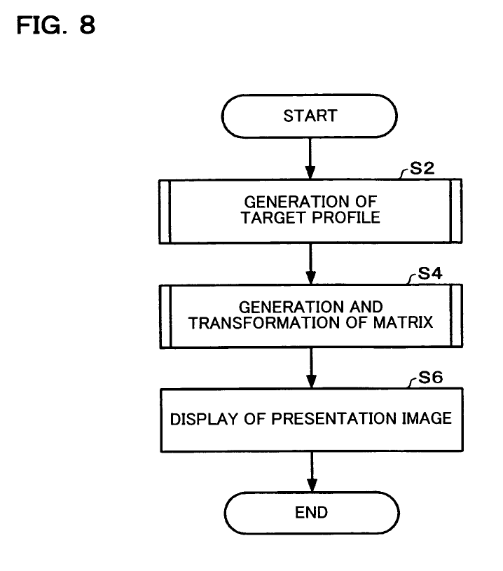

FIG. 8 is a flow chart illustrating a procedure of image processing according to one embodiment of the present invention.

First of all, the user for the projector 20 selects any one of various image characteristics allocated to the respective operation buttons on the projector 20 prior to presentation. More particularly, a plurality of selection buttons relating to image characteristics such as NTSC, PAL, SECAM may be provided on the external surface of the projector 20. The image display system makes the user to push any one of these selection buttons for selecting the corresponding one of the image characteristics.

The projector image processing section 100 then receives this selected information. The projector image processing section 100 then actuates one flag corresponding to the target profile selected among the target profiles in the target profile storing section 162, based on the selected information.

In such a manner, the projector image processing section 100 determines the target profile depending on the user's selection.

The projector 20 then generates a target profile adapting to the viewing environment by correcting the target profile depending on the viewing environment (step S2).

A procedure of generating the target profile (step S2) will now be explained herein.

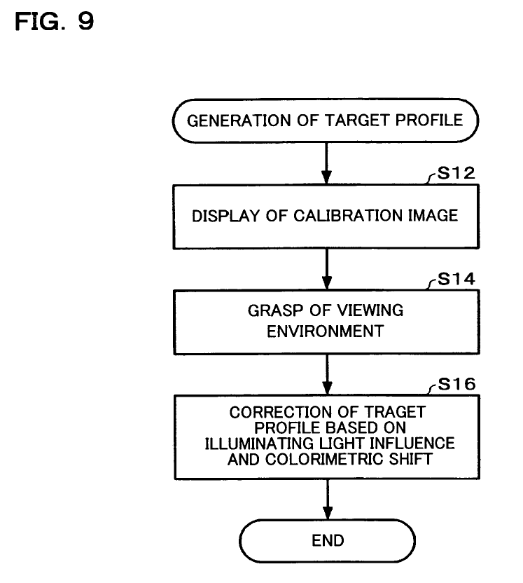

FIG. 9 is a flow chart illustrating a procedure of target profile generation according to one embodiment of the present invention.

After the projector 20 has selected a target profile depending on the user's selection, it causes the calibration signal generating section 150 to generate calibration signals (R2, G2, B2).

The calibration signal generating section 150 then outputs these calibration signals toward the projector color transforming section 120.

The projector color transforming section 120 then uses a default (initial) transforming matrix to transform the calibration signals, the transformed calibration signals being then outputted as digital R-, G- and B-signals (R3, G3, B3).

The D/A converting section 180 then converts these digital R-, G- and B-signals into analog R-, G- and B-signals (R4, G4, B4). The drive 194 then drives the spatial light modulator 192 based on these analog R-, G- and B-signals (R4, G4, B4). The image projecting section 190 then projects the light from the light source 196 through the spatial light modulator 192 and lens 198. In such a manner, the projector 20 will project the calibration images onto the image display region 12 (step S12).

Under such a situation in which the calibration images are being displayed onto the image display region 12, the color light sensor 60 detects tristimulus values to grasp the viewing environment and then outputs them toward the color gamut computing section 160 and target profile correcting section 166 as the environmental information (step S14). Thus, the color gamut computing section 160 and target profile correcting section 166 can grasp the viewing environment.

In such a manner, the projector 20 can use the calibration images to grasp the viewing environment more adequately, resulting in a more proper reproduction of the image color appearance.

The target profile correcting section 166 then corrects the target profile based on the environmental information from the color light sensor 60 (step S16).

In this embodiment, the respective calibration images of red, green, blue, white and black colors are defined by the following signal values:

| | |
|---|---|
| Red: | (R2, G2, B2) = (255, 0, 0); |
| Green: | (R2, G2, B2) = (0, 255, 0); |
| Blue: | (R2, G2, B2) = (0, 0, 255); |
| White: | (R2, G2, B2) = (255, 255, 255); and |
| Black: | (R2, G2, B2) = (0, 0, 0) |

The target profile has a function of associating the R-, G- and B-signal values with coordinates in the standard color space (e.g., CIEXYZ space). For example, if the space represented by the R-, G- and B-signal values is associated with the standard color space under linear transforms, a matrix Mt in the following matrix computing formula 1 can function as target profile.

$$( \begin{matrix}X \\ Y \\ Z\end{matrix} ) = M t ( \begin{matrix}R2 \\ G2 \\ B2\end{matrix} ) \qquad ( Formula 1 )$$

Mt is a three-line-and-three-column matrix. A lookup table (LUT) for storing X-, Y- and Z-values associated with the respective R-, G- and B-signal values can also function as target profile.

The color light sensor 60 determines tristimulus values (Xc, Yc, Zc) on the screen relating to an image (or calibration image) displayed based on a predetermined calibration image signal and then gives them to the target profile correcting section 166. The target profile correcting section 166 computes chromaticity coordinates Wc=(xc, yc) from these tristimulus values according to the following formula:

$$xc = \frac{Xc}{Xc + Yc + Zc}$$

$$yc = \frac{Yc}{Xc + Yc + Zc} \qquad ( Formula 2 )$$

The target profile correcting section 166 then derives a colorimetric shift parameter P1 relating to that calibration image according to the following formula 3. By the way, chromaticity coordinates defined by the non-corrected target profile relating to that calibration image is represented by W=(x,y).

P1=Wc−W=(xc−x, yc−y) (Formula 3)

If it is assumed that the size of a color gamut defined by the non-corrected target profile is S1 and the size of a color gamut which can be expressed under the viewing environment is S2, the target profile correcting section 166 determines an adaptive color shift parameter P2 according to the following formula 4:

P2=P1*S2/S1 (Formula 4)

The target profile correcting section 166 uses the above parameters P1 and P2 to convert chromaticity coordinates Wc=(xc, yc) for a predetermined calibration image into chromaticity coordinates W′=(x′, y′) as shown in the following formula 5. Based on the above-described coordinate W′, the target profile correcting section 160 further derives corrected tristimulus values (X′, Y′, Z′) according to the following formula 6.

W′=(x′, y′)=W+P1+P2=(xc+(xc−x)*S2/S1, yc+(yc−y)*S2/S1) (Formula 5)

$$\begin{matrix}{X}^{′} = {Y}^{′} \times ( \frac{{x}^{′}}{{y}^{′}} ) \\ {Z}^{′} = {Y}^{′} \times ( \frac{{z}^{′}}{{y}^{′}} )\end{matrix} \qquad ( Formula 6 )$$

where Y′ is equal to 100 or Y.

As a result, the inputs (R2, G2, B2) are associated with new coordinates (X′, Y′, Z′). The target profile correcting section 166 will perform such a procedure to a plurality of calibration images to provide new target profiles, that is, corrected target profiles.

The adaptive color shift parameter P2 may be a parameter proportional to the ratio of the color gamut area P1 defined by the non-corrected target profile to the color gamut area S2 reproducible under the viewing environment. Alternatively, the adaptive color shift parameter P2 may be a parameter proportional to the power of the aforementioned ratio or may be equal to S2/D2.

Note that a color gamut area is derived based on chromaticity coordinates associated with the respective displayed red-, green-, blue-color calibration images.

The projector color transforming section 120 then generates a transforming matrix based on the grasped viewing environment and then uses that transforming matrix to transform the image information (step S4).

This procedure of generating and transforming the matrix (step S4) will be described more concretely.

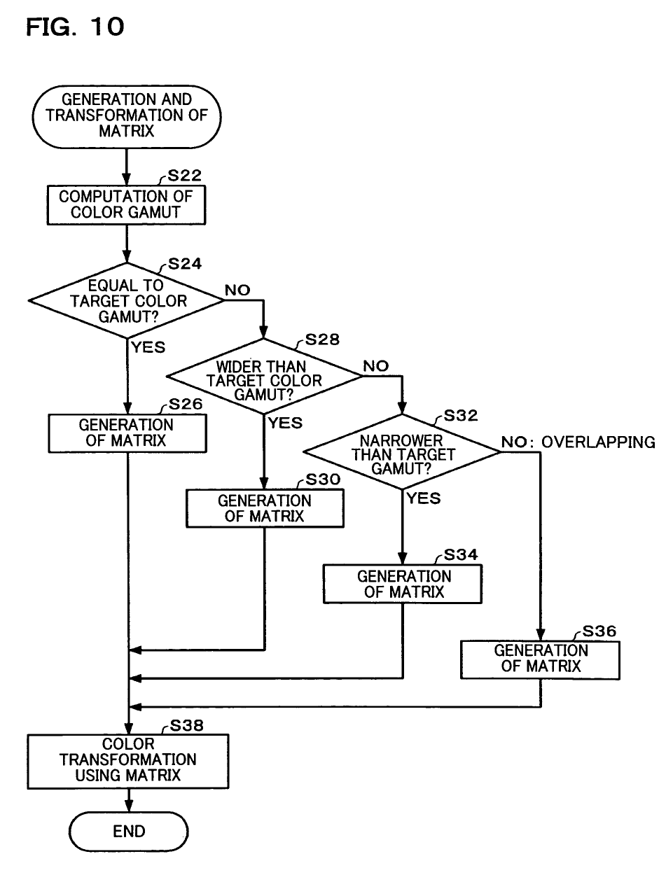

FIG. 10 is a flow chart illustrating a procedure of matrix generation and transformation according to one embodiment of the present invention.

The color gamut computing section 160 computes and determines the target color gamut based on the corrected target profile from the target profile storing section 162. The color gamut computing section 160 computes and determines the displayable color gamut of the projector 20 based on the projector profiles stored in the projector profile storing section 164 and the tristimulus values detected by the color light sensor 60 (step S22).

The color gamut computing section 160 then compares the displayable color gamut with the target color gamut.

First of all, the matrix generating section 122 generates a transforming matrix such that such a triangular mapping color gamut as shown by solid line in FIG. 4B can be reproduced (step S26), if the displayable color gamut is equal to the target color gamut, that is, in a case shown in FIG. 4B (step S24), If the displayable color gamut is wider than the target color gamut, that is, in a case shown in FIG. 4A (step S28), the matrix generating section 122 generates a transforming matrix such that such a triangular mapping color gamut as shown by solid line in FIG. 4A can be reproduced (step S30).

If the displayable color gamut is narrower than the target color gamut, that is, in a case shown in FIG. 5A (step S32), the matrix generating section 122 generates a transforming matrix such that a mapping color gamut in which the reproduction of color gamut or hue is prioritized as shown in FIG. 6A or 6B can be reproduced (step S34).

Any case other than the above three patterns (steps S24, S28 and S32) is when the displayable color gamut has portions overlapping and non-overlapping the target gamut, that is, a case shown in FIG. 5B. In this case, the matrix generating section 122 generates a transforming matrix such that a mapping color gamut in which the reproduction of color gamut or hue is prioritized can be reproduced as shown in FIG. 6A or 6B (step S36).

Note that all of the transforming matrixes generated by the matrix generations (steps S26, S30, S34, S36) are different from one another.

The matrix transforming section 124 then performs the color transformation (transformation of image information) using the transforming matrixes generated by the matrix generating section 122 (step S38). More particularly, the matrix transforming section 124 uses the three-line-and-three-column transforming matrixes to convert the digital R-, G- and B-signals (R2, G2, B2) into the other digital R-, G- and B-signals (R3, G3, B3) which are in turn outputted therefrom.

If this is expressed by a numerical formula, it becomes:

(R3, G3, B3)=M (R2, G2, B2)

where M is a transforming matrix.

The projector 20 causes the D/A converting section 180 to covert the digital converted R-, G- and B-signals (R3, G3, B3) into the analog R-, G- and B-signals (R4, G4, B4) which are in turn used to display an actual presentation image (step S6).

As described, the projector 20 according to this embodiment can correct the target color information based on the environmental information and adaptive color shift information, thereby applying the corrected target color information adaptable to the viewing environment and adaptive color shift to the transformation of color. Thus, the projector 20 can reproduce the color appearance of the image adaptable to the target color.

In particular, the projector 20 which may be influenced by the ambient light such as illuminating light or the other light can correct the target color information for a reduced time period by temporarily grasping the adaptive color shift based on the ratio between several displayable color gamut areas.

The projector 20 according to this embodiment can further transform the image information using the transforming matrix such that an image adaptable to the image characteristic selected by the user can be displayed.

Thus, the image display system which can display the image preferred by the user can be realized.

In this embodiment, the projector 20 further projects the image in consideration of the viewing environment by grasping the viewing environment by the use of the color light sensor 60.

Thus, the projector 20 can display the image adaptable to the viewing environment on image display and can also always display a constant image by absorbing any difference in display environment, without dependent on the applied environment. Therefore, the projector 20 can reproduce substantially the same color in a plurality of different places for a reduced time period.

Furthermore, the projector 20 according to this embodiment can transform the image information at higher speeds and reduce the storage area to be occupied by transforming the image information by the use of the transforming matrixes rather than LUT.

Additionally, the projector 20 according to this embodiment generates a transforming matrix corresponding to one of the four patterns depending on the relationship between the displayable color gamut and the target color gamut.

The relationship between the displayable color gamut and the target color gamut may be varied depending on the environment to which the projector 20 is to be applied or the image characteristic selected by the user. For such a reason, the projector 20 has to generate an appropriate transforming matrix depending on the relationship between the displayable color gamut and the target color gamut.

In this embodiment, the projector 20 can further generate an appropriate transforming matrix depending on the four assumed patterns.

With the patterns shown in FIGS. 4A and 4B, the projector 20 can apply the target color gamut substantially directly to the mapping color gamut, thereby generating the transforming matrix at a speed higher than that of the color gamut mapping as required in FIGS. 5A and 5B.

If the color gamut mapping shown in FIGS. 5A and 5B is required, the projector 20 can reproduce an image more adequately by using the transforming matrix prioritizing the reproducibility of hue or color gamut, in comparison with the case in which the transforming matrix prioritizing the reproducibility of lightness or saturation is used.

Hardware

Note that the following hardware parts may be applied to the respective hardware parts above mentioned.

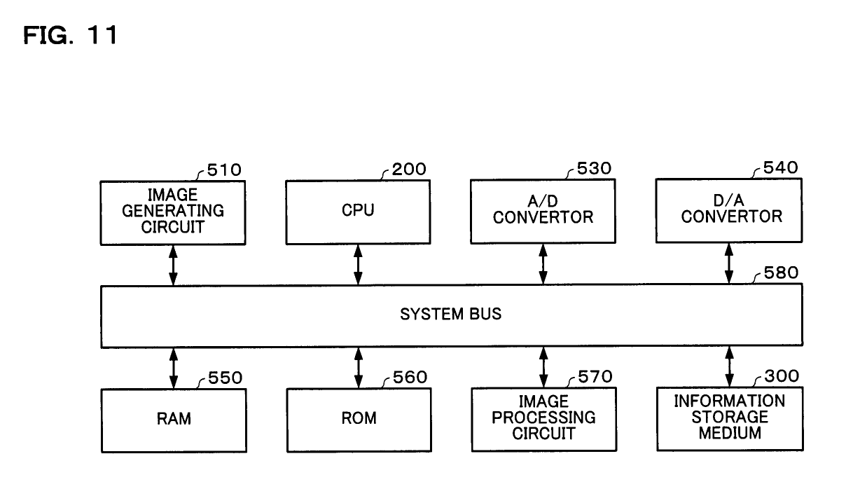

FIG. 11 is a hardware block diagram illustrating an image processing section in a projector according to one embodiment of the present invention.

For example, the A/D converter 110 may be realized by an A/D converter 530; the D/A converter 180 by a D/A converter 540; the spatial light modulator by a liquid crystal panel (not shown); the drive 194 by RAM 550 stored a liquid crystal light valve driver; the projector color transforming section 120 by an image processing circuit 570; the calibration signal generating section 150 by an image generating circuit 510; the color gamut computing section 160 and target profile correcting section 166 by CPU 220 and RAM 550; the target profile storing section 162 by RAM 550; and the projector profile storing section 164 by ROM 560. These sections are configured to mutually deliver the information therebetween through a system bus 580. In addition, these sections and portions may be realized in a hardware manner or in a software manner such as drivers.

The projector 20 may further realize the aforementioned functions by reading a program from an information storage medium 300, as shown in FIG. 7. The information storage medium 300 may be formed by any one of various components such as CD-ROM, DVD-ROM, ROM, RAM, HDD while the information reading mode thereof may be either of the contact or non-contact type.

The projector 20 can also realize the aforementioned functions by downloading a function realizing program from a host device or the like through a transmission path, in place of the information storage medium 300.

Furthermore, the color light sensor 60 may be realized by the following hardware:

For example, it may be realized by a color filter and photodiode for selectively transmitting each of the stimulation values, an A/D converter for converting analog signals from the photodiode into digital signals and an operational amplifier for amplifying the digital signals.

Although the preferred embodiment of the present invention has been described, the present invention may similarly be applied to any one of various other forms.

Modifications

For example, the aforementioned target profile may be image characteristics such as image types of RGB, sRGB and others, rather than the image display mode such as NTSC.

The viewing environment grasp means may be realized by any one of various other image-taking means such as CCD camera, CMOS camera, other than the color light sensor 60.

Although the screen 10 has been described as to the reflecting type, it may be of transmission type.

Although the transforming matrix has been described as to single matrix, it may be a combination of plural matrixes for color transformation.

For example, the color transformation may be carried out, for example, by the use of a combination of an inverse transform matrix depending on the output device with an environment compensation matrix reflected by the environmental information.

The present invention can also be applied to the other presentation in which the image is displayed through any display means other than the projection type image display device such as the aforementioned projector. Such a display means may include CRT (Cathode Ray Tube), PDP (Plasma Display Panel), FED (Field Emission Display), EL (Electro Luminescence), a display device such as direct viewing type liquid crystal display, a projector using DMD (Digital Micromirror Device), in addition to the liquid crystal projector. By the way, DMD is a trademark owned by American Texas Instruments Company. In addition, the projector is not limited to be of front projection type, but it may be of back projection type.

In addition to the presentation, the present invention can effectively be used in meeting, medical care, design and fashion, business activity, commercial, education as well as any general image display such as movie, TV, video and game.

The function of the projector image processing section 100 in the aforementioned projector 20 may be realized by a single image display device (e.g., projector 20) or may be accomplished by a plurality of distributed processing units (e.g., the projector 20 and a personal computer).

Furthermore, the projector 20 may be configured separately from the color light sensor 60 or the projector 20 may be integrated with the color light sensor 60.

1. An image display system that displays an image by transforming image information used to display the image so as to reproduce a target color, based on environmental information from a viewing environment grasp means for grasping a viewing environment in a display region of the image; the image display system comprising:
target color information correcting means for correcting target color information indicating the target color, based on the environmental information and adaptive color shift information indicating an adaptive color shift;
matrix generating means for generating a transforming matrix so as to display the image adaptable to the viewing environment and the target color, based on the corrected target color information;
matrix transforming means for transforming the image information, based on the generated transforming matrix; and
image display means for displaying the image, based on the transformed image information.

2. The image display system as defined in claim 1,
wherein the adaptive color shift information is determined based on the ratio between a color gamut area capable of being displayed by the image display means under a darkroom condition and a color gamut area capable of being displayed by the image display means in the viewing environment.

3. The image display system as defined in claim 2, further comprising:
a color gamut computing means for computing a displayable color gamut which is a color gamut capable of being displayed by the image display means in the viewing environment, based on the environmental information and the corrected target color information,
wherein the matrix generating means generates the transforming matrix which differs among the cases where the displayable color gamut is wider than a target color gamut indicating the color gamut of the target color, where the displayable color gamut is narrower than the target color gamut, where the displayable color gamut is equal to the target color gamut, and where the displayable color gamut includes both overlapping and non-overlapping portions with the target color area.

4. The image display system as defined in claim 3,
wherein the matrix generating means generates the transforming matrix valuing the reproducibility of hue or color gamut when the displayable color gamut is narrower than the target color gamut and when the displayable color gamut includes both overlapping and non-overlapping portions with the target color gamut.

5. An image display system that displays an image by transforming image information used to display the image so as to reproduce a target color, based on environmental information from a viewing environment grasp section grasping a viewing environment in a display region of the image; the image display system comprising:
target color information correcting section correcting target color information indicating the target color, based on the environmental information and adaptive color shift information indicating an adaptive color shift;
matrix generating section generating a transforming matrix so as to display the image adaptable to the viewing environment and the target color, based on the corrected target color information;
matrix transforming section transforming the image information, based on the generated transforming matrix; and
image display section displaying the image, based on the transformed image information.

6. A projector that projects an image by transforming image information used to display the image so as to reproduce a target color, based on environmental information from a viewing environment grasp means for grasping a viewing environment in a display region of the image, the projector comprising:
target color information correcting means for correcting target color information indicating the target color, based on the environmental information and adaptive color shift information indicating an adaptive color shift;
matrix generating means for generating a transforming matrix so as to display the image adaptable to the viewing environment and the target color, based on the corrected target color information;
matrix transforming means for transforming the image information, based on the generated transforming matrix; and
image display means for displaying the image, based on the transformed image information.

7. A projector that projects an image by transforming image information used to display the image so as to reproduce a target color, based on environmental information from a viewing environment grasp section grasping a viewing environment in a display region of the image, the projector comprising:
target color information correcting section correcting target color information indicating the target color, based on the environmental information and adaptive color shift information indicating an adaptive color shift;
matrix generating section generating a transforming matrix so as to display the image adaptable to the viewing environment and the target color, based on the corrected target color information;
matrix transforming section transforming the image information, based on the generated transforming matrix; and
image display section displaying the image, based on the transformed image information.

8. An image processing method of transforming image information used to display an image so as to reproduce a target color, based on environmental information from a viewing environment grasp means for grasping a viewing environment in a display region of the image, the method comprising the steps of:
correcting target color information indicating the target color, based on the environmental information and adaptive color shift information indicating an adaptive color shift;
generating a transforming matrix so as to display the image adaptable to the viewing environment and the target color, based on the corrected target color information, and
transforming the image information, based on the generated transforming matrix.

9. The image processing method as defined in claim 8,
wherein the adaptive color shift information is determined based on the ratio between a color gamut area capable of being displayed by the image display means under a darkroom condition and a color gamut area capable of being displayed by means for displaying the image in the viewing environment.

10. The image processing method as defined in claim 9,
wherein when the transforming matrix is generated, a target color gamut which is a color gamut based on the image characteristics is computed, and at the same time, the displayable color gamut which is a color gamut displayable by means for displaying the image in the viewing environment is computed based on the environmental information, and
wherein the transforming matrix, which differs among the cases where the displayable color gamut is wider than the target color gamut indicating the color gamut of the target color, where the displayable color gamut is narrower than the target color gamut, where the displayable color gamut is equal to the target color gamut, and where the displayable color gamut includes both overlapping and non-overlapping portions with the target color area, is generated.

11. The image processing method as defined in claim 10,
wherein when the transforming matrix is generated, the transforming matrix valuing the reproducibility of hue or color gamut is generated in the cases where the displayable color gamut is narrower than the target color gamut and where the displayable color gamut includes both overlapping and non-overlapping portions with the target color gamut.

12. The image processing method as defined in claim 11, comprising the steps of:
generating a calibration image prior to correcting the image information;
displaying the generated calibration image on the display region; and
grasping the viewing environment in the display region on which the calibration image is displayed and generating the environmental information.

13. A computer-readable information storage medium storing a program for transforming image information used to display an image so as to reproduce a target color, based on environmental information from a viewing environment grasp means for grasping a viewing environment in a display region of the image, the program causing a computer to function as:
target color information correcting means for correcting target color information indicating the target color, based on the environmental information and adaptive color shift information indicating an adaptive color shift;
matrix generating means for generating a transforming matrix so as to display the image adaptable to the viewing environment and the target color, based on the corrected target color information; and
matrix transforming means for transforming the image information, based on the generated transforming matrix.

14. The information storage medium as defined in claim 13,
wherein the adaptive color shift information is determined based on the ratio between a color gamut area capable of being displayed by image display means for displaying the image based on the image information under a darkroom condition and a color gamut area capable of being displayed by the image display means in the viewing environment.

15. The information storage medium as defined in claim 14, causing the computer to function as color gamut computing means for computing a displayable color gamut which is a color gamut capable of being displayed by the image display means in the viewing environment, based on the environmental information and the corrected target color information,
wherein the matrix generating means generates the transforming matrix which differs among the cases where the displayable color gamut is wider than a target color gamut indicating the color gamut of the target color, where the displayable color gamut is narrower than the target color gamut, where the displayable color gamut is equal to the target color gamut, and where the displayable color gamut includes both overlapping and non-overlapping portions with the target color area.

16. The information storage medium as defined in claim 15,
wherein the matrix generating means generates the transforming matrix valuing the reproducibility of hue or color gamut in the cases where the displayable color gamut is narrower than the target color gamut and where the displayable color gamut includes both overlapping and non-overlapping portions with the target color gamut.
